(19) United States
(12) Patent Application Publication
(10) Pub. No.: US 2006/0031334 A1
(43) Pub. Date: Feb. 9, 2006

(54) Methods and systems for forwarding electronic communications to remote users

(76) Inventor: Mike Insang Kim, Rancho Santa Margarita, CA (US)

Correspondence Address: STETINA BRUNDA GARRED & BRUCKER, 75 ENTERPRISE, SUITE 250, ALISO VIEJO, CA, 92656, US

(21) Appl. No.: 10/911,328

(22) Filed: Aug. 4, 2004

(51) Int. Cl. G06F 15/16

(52) U.S. Cl. 709/206

(57) ABSTRACT

An electronic message forwarding system is provided for selectively converting and forwarding email messages and text messages, thereby allowing users of the system to maintain email and text message communications with other users. The online status of an email computing device associated with a user of the system can be detected. Email messages directed toward the user can be converted into text message format and received by a mobile computing device associated with the user if the email computing device is offline. Text messages directed toward the user can be converted into email message format and received by the email computing device if the email computing device is online. The forwarding of email and text messages by the system can also be conditioned on various message forwarding preferences of the user.

### CROSS-REFERENCE TO RELATED APPLICATIONS

Not Applicable

### STATEMENT RE: FEDERALLY SPONSORED RESEARCH/DEVELOPMENT

Not Applicable

### FIELD OF THE INVENTION

The present invention relates generally to electronic messaging technology, and more particularly to methods and systems for forwarding messages between sending parties and receiving parties using different communication media.

### BACKGROUND OF THE INVENTION

The proliferation of email, text messaging, and other communication media in recent years has provided consumers with a diverse set of communication tools. As a result, it is often necessary to use more than one form of media to maintain communication with other persons.

Unfortunately, the large number of available communication tools can present a bewildering array of choices to persons when they are seeking the most efficient way to contact others. For example, although email can provide a convenient, quick way to communicate certain information, there is no guarantee that an intended email recipient will be at an email computing device to actually receive email messages. While email messages may be queued for later viewing, such functionality does not allow the email recipient to view such messages until the recipient physically returns to an appropriate email computing device.

Text messaging functionality offered by various wireless devices can enable users to receive electronic messages in text message format while they are mobile. Nevertheless, it is still incumbent on the message sender to determine whether to send an email message, text message, or both. This uncertainty forces the message sender to guess as to which form of communication media should be used to contact the intended message recipient. Moreover, once the choice is made, the sending party still does not have assurance that the message will be sent to a computing device to which the intended receiving party currently has access.

Accordingly, there exists a need for a comprehensive system which provides a streamlined approach to email and text messaging communication. It would be desirable for such a system to allow electronic messages to be forwarded to an appropriate mobile computing device in order that a receiving party can continue to receive email and/or text messages while away from an email computing device. It would be further desirable for such a system to convert email messages to text messages, and vice versa, to facilitate the forwarding of such messages.

### BRIEF SUMMARY OF THE INVENTION

The present invention, roughly described, is directed to methods and systems that allow users to maintain email and text message communications with other users, without having to be physically present at an email computing device.

In various embodiments, functionality for selectively forwarding electronic messages from a sending party to a receiving party according to message forwarding preferences of the receiving party can be provided by appropriate methods and systems. An electronic message sent from the sending party can be received by a system server, and message forwarding preferences of the receiving party can be accessed from a database. The online status of an email computing device associated with the receiving party can be detected. Data packets generated by a software program running on the email computing device can be periodically sent to a system server in order to inform the server that the email computing device is currently online. If a data packet is not received by the system server within a preselected time period, the system server can determine that the email computing device is no longer online.

Upon a comparison of the detected online status with the message forwarding preferences, the electronic message can be selectively forwarded to the email computing device or a mobile computing device associated with the receiving party. Electronic messages in the form of email messages can be selectively converted into text message format and forwarded to the mobile computing device of the receiving party while the email computing device is offline. Similarly, electronic messages in the form of text messages can be selectively converted into email message format and forwarded to the email computing device of the receiving party if the email computing device is online.

In certain embodiments, the message forwarding preferences of the receiving party can specify various criteria to be met in order for email messages to be converted to text message format and forwarded to the mobile computing device. Such criteria can include, but need not be limited to: particular sending parties, time, date, whether the receiving party is logged in to a web site, and/or other criteria.

These and other embodiments of the present invention are discussed in further detail below.

### BRIEF DESCRIPTION OF THE DRAWINGS

FIG. 1 is a block diagram illustrating an electronic message forwarding system in accordance with an embodiment of the present invention.

FIG. 2 is a flowchart describing a process for informing a system server of an online status of an email computing device in accordance with an embodiment of the present invention.

FIG. 3 is a flowchart describing a process for detecting an online status of an email computing device in accordance with an embodiment of the present invention.

FIG. 4 is a flowchart describing a process for selectively converting and forwarding email messages in accordance with an embodiment of the present invention.

FIG. 5 is a flowchart describing a process for selectively converting and forwarding text messages in accordance with an embodiment of the present invention.

FIG. 6 is a flowchart describing a process for user interaction with an electronic message forwarding system in accordance with an embodiment of the present invention.

### DETAILED DESCRIPTION OF THE INVENTION

A message forwarding system in accordance with the present invention can provide functionality for selectively converting electronic mail messages (“email messages”) into text messages compatible with mobile devices, and vice versa. In various embodiments, a user of the message forwarding system can send and receive messages to and from other users of the system, regardless of whether the user currently has access to an email computing device.

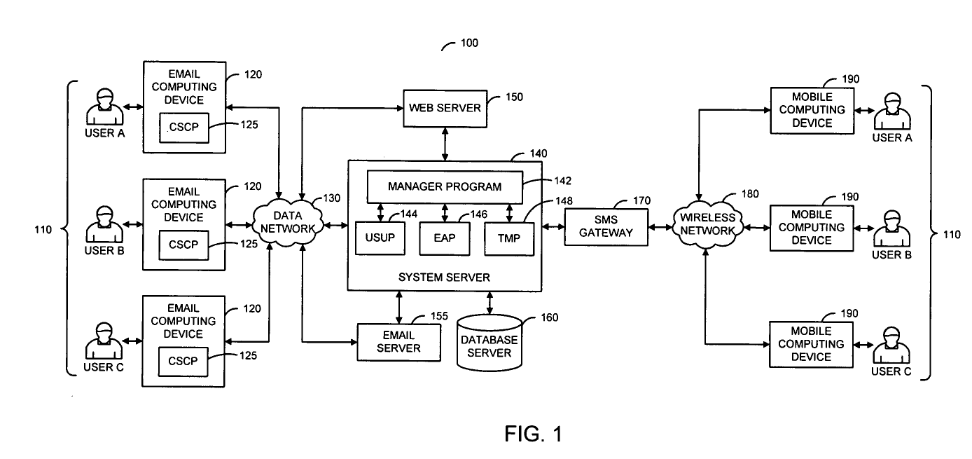

FIG. 1 is a block diagram illustrating an electronic message forwarding system 100 in accordance with an embodiment of the present invention. Using system 100, a plurality of users 110 can interact with each other through various email computing devices 120 and mobile computing devices 190. As further described herein, email and text messages can be exchanged between users 110 through their associated email computing devices 120 and mobile computing devices 190 in accordance with message forwarding preferences of the users 110.

As illustrated in FIG. 1, each user 110 of system 100 can have an associated email computing device 120 and mobile computing device 190. Email computing devices 120 can be any computing devices known in the art capable of sending, receiving, and/or displaying email messages to a user 110. In various embodiments, computing devices 120 can be conventional personal computers, laptop computers, workstations, terminals, and/or any other type of computing device known in the art. Mobile computing devices 190 can be any appropriate mobile computing devices known in the art capable of sending and/or receiving text messages over a wireless network 180, and displaying such text messages to a user 110. It will be appreciated that mobile computing devices 190 can be mobile phones, personal digital assistants, and/or any other type of computing device known in the art. Although computing devices 120 and mobile devices 190 are described more fully herein in relation to email and text messages, respectively, it will be appreciated that support for other types of electronic messages is also contemplated by the present invention.

The message forwarding system 100 can advantageously detect whether an email computing device 120 associated with a particular user 110 is online. If the associated email computing device 120 is online, then email messages intended for the user can be routed to the user's email address, and text messages intended for the user can be converted into email messages for routing to the user's email address. However, if the email computing device 120 is offline, then text messages intended for the user can be routed to the user's mobile computing device 190, and email messages intended for the user can be converted into text messages which are forwarded to the user's mobile computing device 190. As a result, users of system 100 can view email messages as text messages while away from an email computing device 120, and can further view text messages as email messages while at the email computing device 120.

Each of email computing devices 120 can communicate with a data network 130 which facilitates communication between various components of system 100. For example, email messages sent from email computing devices 120 over network 130 can be received by an email server 155 for further processing by system 100. Network 130 can be any of the various networks known in the art to facilitate data transmission, including but not limited to the Internet, a wide area network (WAN), a virtual private network (VPN), a wireless network, and/or others known in the art.

System 100 can optionally provide a web site through a web server 150 permitting users 110 to login and/or register with the system 100 by providing registration information through the web site. Users 110 who are registered members of the system 100 can be permitted to enter their message forwarding preferences through the web site, as further described herein.

A system server 140 provides the message routing and conversion functionality of system 100. As illustrated, system server 140 is in communication with a web server 150, email server 155, database server 160, SMS gateway 170, and network 130. Various software applications 142, 144, 146, and 148 can be provided on system server 140 for instructing the server 140 to perform specific functionality described more fully herein. Message forwarding preferences of users 110 can be stored in database server 160 which is in communication with system server 140. Such message forwarding preferences can include preferences selected by users 110 pertaining to the manner and conditions under which electronic email and/or text messages will be converted and/or forwarded by system server 140 to the email computing devices 120 and/or mobile computing devices 190 of users 110. For example, such conditions can include but need not be limited to: the message sender, time, date, on/off/idle status of a user's 110 email computing device 120, and/or other conditions. In one embodiment, the message forwarding preferences can specify that all email and/or text messages received from a particular set of users 110 of system 100 (or other persons) should be forwarded to a receiving party's mobile computing device 190 whenever the receiving party's email computing device 190 is offline.

Email server 155 is in communication with network 130 and system server 140 for receiving email messages sent by one or more email computing devices 120 and passing such email messages to system server 140. Database server 160 is in communication with system server 140 for storing message forwarding preferences of users 110.

SMS gateway 170 is in communication with system server 140 and a wireless network 180, thereby facilitating communication between system server 140 and the wireless network 180. Wireless network 180 can be any appropriate network that facilitates wireless communication to and from mobile computing devices 190, such as GSM/PCS digital cellular network or others known in the art.

Each of mobile computing devices 190 can communicate with wireless network 180 for exchanging text messages with other components of the system 100. For example, text messages sent from mobile computing devices 190 over network 180 can be received by SMS gateway 170 for further processing by system 100.

A client status checking program (“CSCP”) 125 is provided on each email computing device 120. As further described herein, CSCP 125 operates to send information to system server 140 while the email computing device 120 is online. When a user 110 turns on an email computing device 120, CSCP 125 can be executed automatically and loaded into the memory of the email computing device 120. In various embodiments, CSCP 125 can generate data packets which contain a user's settings, name, and login status. Such packets are sent through network 130 to system server 140.

Turning now to the software applications running on system server 140, it will be appreciated by those skilled in the art that discreet software applications 142, 144, 146, and 148 are illustrated as running on system server 140. However, any appropriate arrangement of software components can be employed to provide the functionality of system server 140 described herein. It will also be appreciated that although database server 160 is illustrated as separate from system server 140, the storage of user message forwarding preferences can be provided in accordance with any storage technology known in the art, including but not limited to one or more separate databases.

A user status update program (“USUP”) 144 is provided on system server 140 for receiving and analyzing data packets transmitted by the various CSCP 125 programs running on email computing devices 120. USUP 144 waits to receive a data packet from CSCP 125 within a predetermined time interval. If no data packet is received within the time interval, then the USUP 144 determines that the email computing device 120 is offline. If a data packet is received, then USUP 144 determines that the email computing device 120 is online. The USUP 144 then decodes the data packet and updates the online status associated with the email computing device 120 running the CSCP 125. USUP 144 can also be provided with functionality for updating user settings extracted from such data packets and updating those settings in database server 160. In various embodiments, USUP can be implemented as a software program written in ASP, VC++, and VB programming languages.

A manager program 142 is also provided on system server 140 for managing the selective forwarding of electronic messages in accordance with the present invention. Manager program 142 receives data from USUP 144 as to which email computing devices 120 are online. In response to a detected online status, manager program 142 can selectively convert electronic messages received in email format into text message format, and vice versa. The converted messages can then be forwarded to an email computing device 120 and/or mobile computing device 190 as desired.

An email analyze program (“EAP”) 146 is further provided on system server 140 for analyzing email messages received from email server 155. In various embodiments, EAP 146 can analyze the header of such email messages and identify the sending and receiving parties. If both parties are authorized users of system 100, or have software sufficient to interact with system server 140, then such email messages will be passed to manager program 140.

A text messaging program (“TMP”) 148 is also provided on system server 140 for sending and receiving text messages between system server 140 and SMS gateway 170.

CSCP 125 can be implemented as a client side software program written in VC++ and VB programming languages. In various embodiments, CSCP 125 is preinstalled into each of computing devices 120 before such devices can interact with system 100.

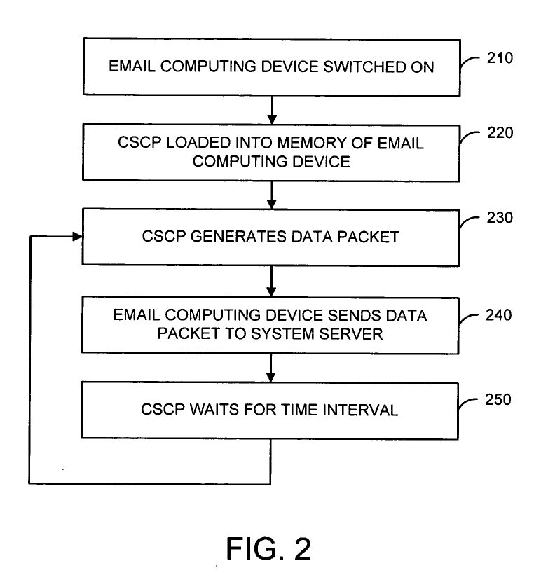

FIG. 2 is a flowchart describing a process for informing system server 140 of an online status of an email computing device 120 in accordance with an embodiment of the present invention.

In initial step 210, an email computing device 120 is switched on and begins its boot up cycle. Typically, step 210 will be performed in response to a user's 110 decision to switch on the email computing device 120. During the boot up cycle, CSCP 125 is loaded into the memory of device 120 and begins running (step 220).

While the CSCP 125 is running, it periodically generates a data packet (step 230) to be sent by the email computing device 120. The data packet sent in step 230 can comprise any desired collection of data desirable to be sent to system server 140. For example, the data packet could identify the user's 110 name, message forwarding preferences, login status, and/or other information.

In step 240, the data packet is sent by the email computing device to system server 140 over network 130. After the data packet is sent, the CSCP 125 waits for a preselected time interval (step 250) before returning to step 230 and generating the next data packet. In various embodiments, the time interval identified in step 250 can be set by the user 110 as part of the user's 110 message forwarding preferences.

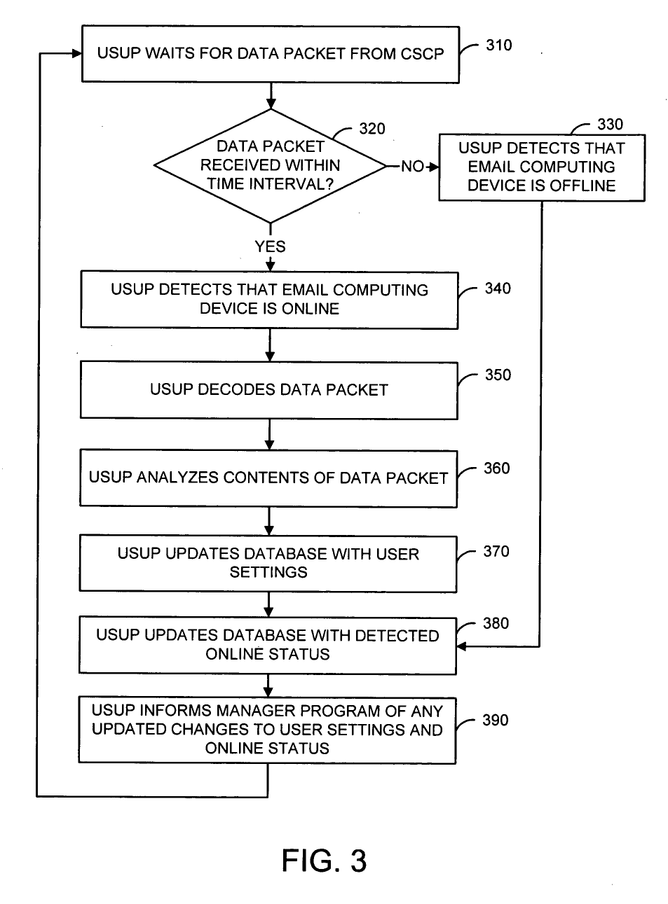

It will be appreciated that steps 230, 240, and 250 collectively identify an iterative process during which data packets are periodically sent from the email computing device 120 to system server 140. However, the iterative process can be interrupted if CSCP 125 stops functioning and/or if the email computing device 120 is switched off. CSCP 125 can also be implemented to perform the iterative process only while a user 110 is logged in to the email computing device 120 and/or is logged in to a website provided by web server 150. Similarly, if communications between email computing device 120 and network 130 are interrupted, then data packets sent by the email computing device 120 will not be received by system server 140. As further described herein in relation to FIG. 3, the interruption of this iterative process can facilitate the detection by system server 140 of whether the email computing device 120 is online.

FIG. 3 is a flowchart describing a process for detecting an online status of an email computing device 120 in accordance with an embodiment of the present invention. The process of FIG. 3 can be performed by the USUP 144 software running on system server 140.

At step 310, USUP 144 waits to receive a data packet from the CSCP 125 program running on an email computing device 120. If no data packet is received within a predetermined time interval (step 320), then USUP 144 detects that the email computing device 120 is offline (step 330), and the process of FIG. 3 proceeds to step 380.

If, however, a data packet is received by USUP 144 (step 320), then USUP 144 detects that the email computing device 120 is online (step 340). USUP 144 then decodes the data packet (step 350) and analyzes the contents (step 360). USUP 144 updates database server 160 with any user settings contained in the data packet, such as message forwarding preferences of the user (step 370).

At step 380, USUP 144 updates the database server 160 with the online status detected in step 330 (if no data packet was received) or step 340 (if a data packet was received). USUP 144 informs the manager program 142 of any changes to the user's 110 settings and online status of the user's 110 email computing device 120. The process then returns to step 310 where USUP 144 waits for the next data packet to arrive.

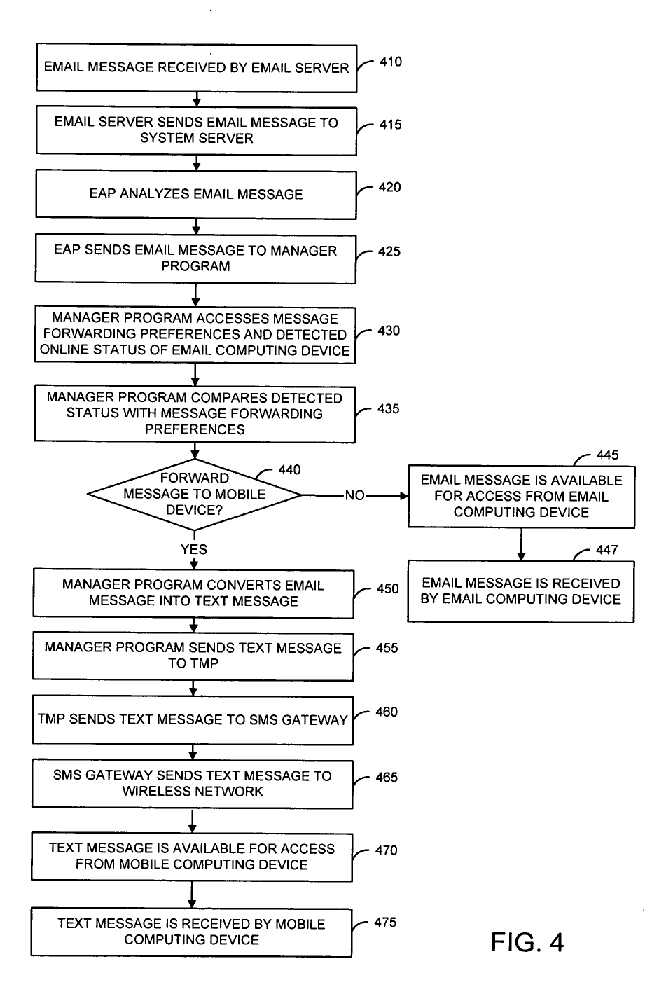

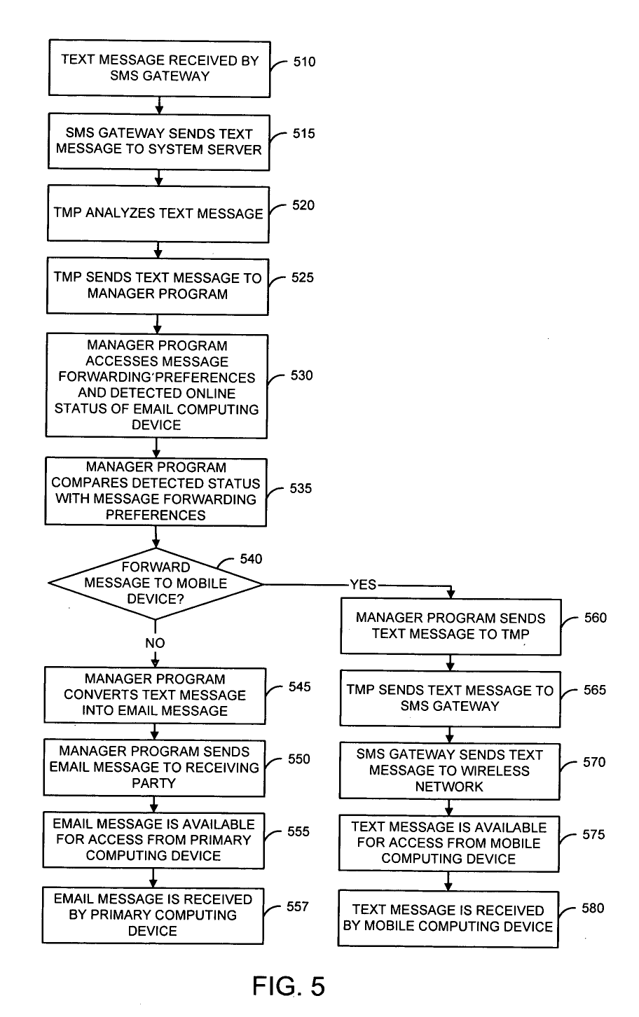

It will be appreciated that process of FIG. 3 provides system server 140 with an online status associated with a given email computing device 120 (i.e. whether the email computing device 120 is online or offline). As explained in relation to FIGS. 4 and 5 below, this online status can be used by software running on system server 140 to take appropriate action in converting and/or forwarding electronic messages to appropriate computing devices for users 110 of system 100.

FIG. 4 is a flowchart describing a process for selectively converting and forwarding email messages in accordance with an embodiment of the present invention.

At step 410, email server 155 receives an email message over network 130. The email server 155 then sends the message to system server 140 (step 415). At step 420, EAP 146 running on system server 140 analyzes the email message to determine the sending party and the intended receiving party indicated by the email message. In one embodiment, EAP 146 reviews the email message to determine whether the sending party and/or the receiving party is a registered user 110 of system 100. In another embodiment, EAP 146 reviews the header portion of the email message to determine whether it contains an email address of a user 110 of system 100. EAP 146 then sends the email message to manager program 142 (step 425).

Upon receiving the email message, manager program 142 accesses the message forwarding preferences of the receiving party designated by the email message, and further accesses the detected online status of the email computing device 120 associated with the receiving party (step 430). In one embodiment, the information accessed in step 430 is obtained from database server 160. In another embodiment, such information is obtained from USUP 144.

At step 435, manager program 142 compares the detected online status (accessed in step 430) with the message forwarding preferences (also accessed in step 430) to obtain a comparison result. In response to the comparison result, manager program 142 determines whether the email message should be forwarded to a mobile device 190 associated with the receiving party (step 440).

For example, if the receiving party's message forwarding preferences indicate that email messages from the sending party should be forwarded to the receiving party's mobile device 190 when the receiving party's email computing device 120 is offline, then the process of FIG. 4 will proceed to step 450 if the online status (detected in FIG. 3) indicates that the email computing device 120 is offline. Otherwise, the process proceeds to step 445 where the email message is made available for access from the email computing device 120 and can be received by the email computing device 120 when the receiving party checks the email computing device 120 for email messages (step 447).

At step 450, manager program 142 converts the email message into a text message suitable for transmission to a mobile computing device 190. The manager program 142 then sends the newly converted text message to TMP 148 (step 455) which proceeds to send the text message to SMS gateway 170 (step 460). Upon receiving the text message, the SMS gateway sends the text message to wireless network 180 (step 465) where it is available for access from the receiving party's mobile device 190 (step 470). The converted text message will then be received by the mobile device 190 (step 475) when the receiving party checks the mobile device 190 for text messages.

In addition to the particular embodiment set forth in the discussion of FIG. 4 above, it will be appreciated that system 100 can also be implemented to always make email messages available for access from the receiving party's associated email computing device 120 and/or mobile computing device 190, regardless of whether the messages are also forwarded to another computing device associated with the receiving party.

FIG. 5 is a flowchart describing a process for selectively converting and forwarding text messages in accordance with an embodiment of the present invention.

At step 510, SMS gateway 170 receives a text message over wireless network 180. SMS gateway 170 then sends the message to system server 140 (step 515). At step 520, TMP 148 analyzes the text message to determine the sending party and intended receiving party indicated by the text message. In one embodiment, TMP 148 reviews the text message to determine whether the sending party and/or the receiving party is a registered user 110 of system 100. TMP 148 then sends the text message to manager program 142 (step 525).

Upon receiving the text message, manager program 142 accesses the message forwarding preferences of the receiving party designated by the email message, and further accesses the detected online status of the email computing device 120 associated with the receiving party (step 530). In one embodiment, the information accessed in step 530 is obtained from database server 160. In another embodiment, such information is obtained from USUP 144.

At step 535, manager program 140 compares the detected online status (accessed in step 530) with the message forwarding preferences (also accessed in step 530) to obtain a comparison result. In response to the comparison result, manager program 142 can determine whether the text message should be forwarded to a mobile device 190 or email computing device 120 associated with the receiving party (step 540).

If the message forwarding preferences indicate that text messages from the sending party should be forwarded to the receiving party's mobile device 190 when the receiving party's email computing device 120 is offline, then the process of FIG. 5 will proceed to step 560 if the detected online status indicates that the email computing device 120 is offline. 10058] If it is determined that the text message should not be forwarded to the receiving party's mobile computing device 190 (step 540), then manager program 142 generates an email message by converting the text message into an email message format (step 545). Manager program 142 then sends the converted email message to the email address of the receiving party (step 550). Thereafter, the converted email message can be available for access from the email computing device 120 (step 555) and can be received at the email computing device 120 (step 557) when the receiving party checks the email computing device 120 for email messages.

If it is determined that the text message should be forwarded to the receiving party's mobile computing device 190 (step 540), then manager program 142 sends the text message to TSP 148 (step 560) which sends the text message to SMS gateway 170 (step 565). Upon receiving the text message, the SMS gateway sends the text message to wireless network 180 (step 570) where it is available for access from the receiving party's mobile device 190 (step 575). The converted text message will then be received by the mobile device 190 (step 580) when the receiving party checks the mobile device 190 for text messages.

In addition to the particular embodiment set forth in the discussion of FIG. 5 above, it will be appreciated that system 100 can also be implemented to always make text messages available for access from the receiving party's associated email computing device 120 and/or mobile computing device 190, regardless of whether the messages are also forwarded to another computing device associated with the receiving party.

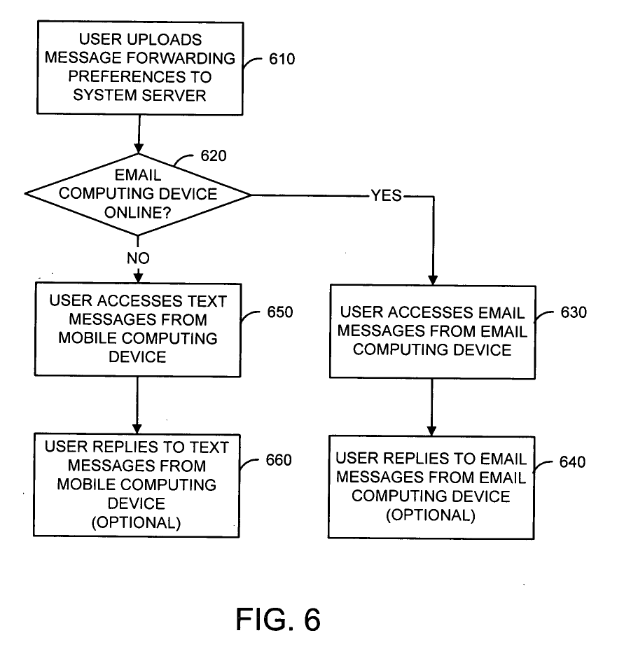

FIG. 6 is a flowchart describing a process for user 110 interaction with an electronic message forwarding system 100 in accordance with an embodiment of the present invention. It will be appreciated that the steps of FIG. 6 illustrate the perspective of a typical user 110 of system 100, such as a receiving party having an associated email computing device 120 and mobile computing device 190.

At initial step 610, the user 110 uploads the user's 110 desired message forwarding preferences to system server 140. It will be appreciated that step 610 can be performed by the user 110 inputting the message forwarding preferences into a web page provided by web server 150, or through any of the various ways known in the art for providing data to a server. In response, system server 140 stores the preferences on database server 160. Thereafter, system 100 will forward and/or convert email messages and text messages directed toward the user in accordance with the stored message forwarding preferences.

If the user's 110 email computing device 120 is online (step 620), then the user 110 can access email messages (including text messages converted into email messages) from the user's 110 email computing device 120 (step 630). The user 110 can optionally reply to the email messages (step 640) from the email computing device 120. In contrast, if the user's 110 email computing device 120 is offline (step 620), then the user 110 can access text messages (including email messages converted into text messages) from the user's 110 mobile computing device 190 (step 650). The user 110 can optionally reply to the text messages (step 660) from the mobile computing device 190.

It will be appreciated that if the user 110 chooses to send an email message (step 630) or text message (step 660) to a second user 110 of system 100, then such messages can be processed by system 100 in accordance with the message forwarding preferences of the second user 110. Thus, by setting the message forwarding preferences as desired, any of the users 110 of system 100 can maintain email and text message communications with other users 10 of the system 100, regardless of whether the users 110 are physically present at an email computing device 120.

It will be appreciated that the scope of the present invention is not limited by the particular embodiments set forth herein. Other appropriate variations, whether explicitly provided for or implied, are contemplated by the present disclosure. The ordering of various steps described herein can be changed where appropriate to achieve the functionality provided by the present invention. Similarly, individual steps can be combined and/or dissected into fewer or greater numbers of steps where appropriate to provide the functionality described herein.

What is claimed is:

1. A method for selectively forwarding electronic messages from a sending party to a receiving party according to message forwarding preferences of the receiving party, the receiving party having a first associated computing device, the method comprising:
receiving an electronic message from the sending party;
accessing message forwarding preferences of the receiving party, the receiving party being identified by the message;
detecting an online status of the first associated computing device;
comparing the detected online status with the message forwarding preferences to obtain a comparison result; and
forwarding the message to the receiving party in response to the comparison result.

2. The method of claim 1, the forwarding step comprising:
routing the electronic message to a second computing device associated with the receiving party if the detected online status indicates the first computing device is offline.

3. The method of claim 2, the first computing device is an email computing device, the second computing device is a mobile computing device.

4. The method of claim 3, the method further comprising:
converting the electronic message from an email message into a text message prior to the forwarding step.

5. The method of claim 3, the mobile computing device is a mobile phone.

6. The method of claim 3, the email computing device is a personal computer.

7. The method of claim 1, the forwarding step comprising:
routing the electronic message to the first computing device if the detected online status indicates the first computing device is online, the first computing device is an email computing device.

8. The method of claim 7, the method further comprising:
converting the electronic message from a text message into an email message prior to the forwarding step.

9. The method of claim 1, the message forwarding preferences identifying at least a set of users, the forwarding step comprising:
routing the email message to a mobile computing device of the receiving party if the sending party is a member of the set of users.

10. The method of claim 1, the forwarding step comprising:
routing the email message to a mobile device of the receiving party if:
the sending party is a member of the set of users, and
the detected online status indicates the first computing device is offline.

11. The method of claim 1, the message forwarding preferences comprising information selected from the group consisting of:
a set of users;
a time;
a date; and
a user login status.

12. The method of claim 1, the detecting step comprising:
receiving a data packet from the first computing device; and
storing the online status in response to receiving the data packet.

13. The method of claim 1, the method is performed by software running on a system server.

14. A method for facilitating a user's receipt of messages from preferred sending parties, the user having a first associated computing device and a second associated computing device, the method comprising:
setting message forwarding preferences of the user in a database; and
receiving an electronic message directed toward the user, the message being received by the second computing device of the user if a detected online status of the first computing device indicates that the first computing device is offline.

15. The method of claim 14, the first computing device is an email computing device, the second computing device is a mobile computing device.

16. The method of claim 15, the mobile computing device is a mobile phone.

17. The method of claim 15, the email computing device is a personal computer.

18. The method of claim 14, the message forwarding preferences comprising information selected from the group consisting of:
a set of users;
a time;
a date; and
a user login status.

19. A system for selectively forwarding electronic messages from a sending party to a receiving party according to message forwarding preferences of the receiving party, the receiving party having a first associated computing device, the system comprising:
a system server;
a database for storing the message forwarding preferences; and
application software running on the system server operable to perform the steps of:
receiving an electronic message from the sending party,
accessing message forwarding preferences of the receiving party from the database, the receiving party being identified by the message,
detecting an online status of the first associated computing device,
comparing the detected online status with the message forwarding preferences to obtain a comparison result, and
forwarding the message to the receiving party in response to the comparison result.

20. The system of claim 19, the system further comprising:
a web server; and
a web site provided by the web server for receiving registration information from the receiving party.

21. The system of claim 19, the forwarding step comprising:
routing the electronic message to a second computing device associated with the receiving party if the detected online status indicates the first computing device is offline.

22. The system of claim 21, the first computing device is an email computing device, the second computing device is a mobile computing device.

23. The system of claim 22, the software being further operable to perform the step of:
converting the electronic message from an email message into a text message prior to the forwarding step.

24. The system of claim 19, the forwarding step comprising:
routing the electronic message to the first computing device if the detected online status indicates the first computing device is online, the first computing device is an email computing device.

25. The system of claim 24, the software being further operable to perform the step of:
converting the electronic message from a text message into an email message prior to the forwarding step.

26. The system of claim 19, the message forwarding preferences identifying at least a set of users, the forwarding step comprising:
routing the email message to a mobile computing device of the receiving party if the sending party is a member of the set of users.

27. The system of claim 19, the forwarding step comprising:
routing the email message to a mobile device of the receiving party if:
the sending party is a member of the set of users, and
the detected online status indicates the first computing device is offline.

28. The system of claim 19, the message forwarding preferences comprising information selected from the group consisting of:
a set of users;
a time;
a date; and
a user login status.

29. The system of claim 19, the detecting step comprising:
receiving a data packet from the first computing device; and
storing the online status in response to receiving the data packet.
